(19) United States
(12) Patent Application Publication
(10) Pub. No.: US 2010/0075752 A1
(43) Pub. Date: Mar. 25, 2010

(54) Computer game

(76) Inventor: Yasha Feldman, Brooklyn, NY (US)

Correspondence Address: ILYA ZBOROVSKY, 6 Schoolhouse Way, Dix Hills, NY, 11746, US

(21) Appl. No.: 12/284,530

(22) Filed: Sep. 24, 2008

(51) Int. Cl. A63F 13/00

(52) U.S. Cl. 463/31

(57) ABSTRACT

A computer game which has a computer with a computer program and a controller, and monitor for exhibiting an image of an agent moving toward the place where a secret document is hidden, wherein the computer program and the controller are designed so that a player by using said controller moves the image of an agent to overcome a plurality of obstacles to reach a foreign country, to travel in a foreign country, to find a building where the secret document is hidden, to overwhelm cards, to get in the building, to find the secret document, and to take it to his superiors.

### BACKGROUND OF THE INVENTION

The present invention relates to electronic computer games, and methods of playing the same.

Electronic computer games are known in wide varieties. It is believed that it is advisable to provide other electronic computer games which can be attractive for players.

### SUMMARY OF THE INVENTION

Accordingly, it is an object of the present invention to provide an electronic computer game and a method of playing the same which can be attractive for players.

More particularly it is an object of the present invention to provide a computer game and a method for playing the same, in which a main features of a computer game include an agent (a spy) which has to obtain certain secret documents.

In keeping with these objects and with others which will become apparent hereinafter, one feature resides, briefly stated, in a computer game which has a computer with a computer program and a controller; and monitor for exhibiting an image of an agent moving toward the place where a secret document is hidden, wherein said computer program and said controller are designed so that a player by using said controller moves the image of an agent to overcome a plurality of obstacles to reach a foreign country, to travel in a foreign country, to find a building where the secret document is hidden, to overwhelm cards, to get in the building, to find the secret document, and to take it to his superiors.

Another feature of the present invention resides, briefly stated, and a method of playing a computer game, comprising the steps of providing a computer game which has a computer with a computer program and a controller; and monitor for exhibiting an image of an agent, and moving the agent toward the place where a secret document is hidden, wherein said computer program and said controller are designed so that a player by using said controller moves the image of an agent to overcome a plurality of obstacles to reach a foreign country, to travel in a foreign country, to find a building where the secret document is hidden, to overwhelm cards, to get in the building, to find the secret document, and to take it to his superiors.

When the computer game is designed and the method is performed in accordance with the present invention, a very high attractiveness for players is achieved because of a variety of various game effects.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing components of a new computer game; and

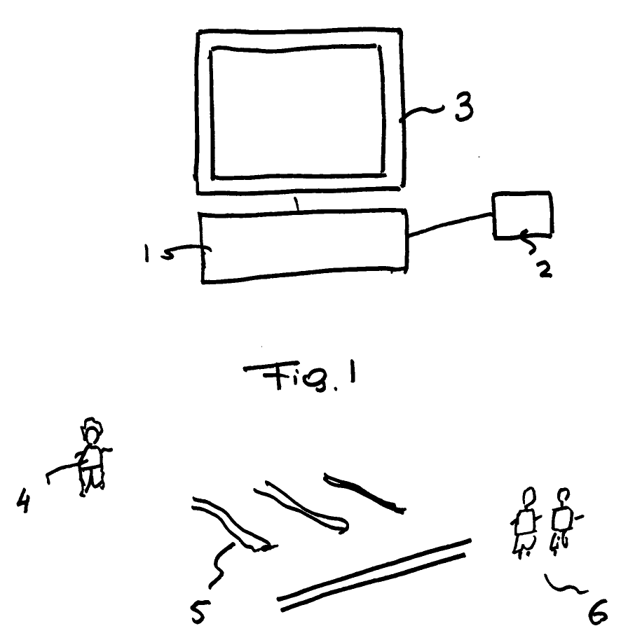

FIG. 2 is a flow chart showing the steps of the computer game.

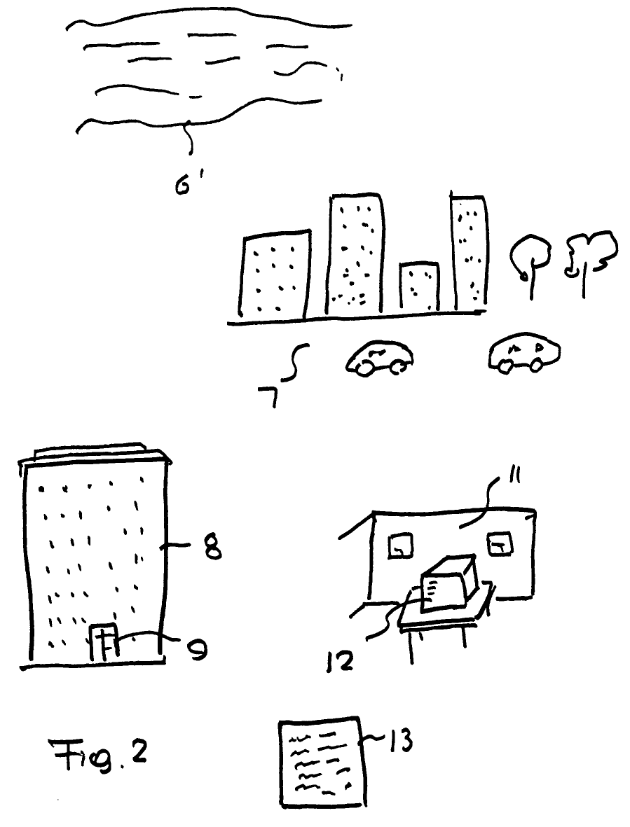

### DESCRIPTION OF THE PREFERRED EMBODIMENTS

In a new computer program game in accordance with the present invention an image of an agent or a spy is utilized, which moves to find a secret document which he has to find in a foreign country.

The image of the agent is displayed and moved by a player. For this purpose the game has a computer which is identified with reference numeral 1 and provided with a computer program (software) and a controller which is identified with reference numeral 2. The computer has a monitor 3 on which the image of the agent is moved in correspondence with the rules of the game represented by the program (software).

An agent 4 obtains an order to find a secret document. He is armed with corresponding means and moves toward a state border with a foreign country. He can have a gun and containers with paralyzing substances. Several paths 5 lead to the state border, and at the state border there are border patrol 6. The agent picks a correct path, goes around the controls and reaches the border of the foreign country.

The player tries several different paths, and when the mistake is made the game will start from the beginning. He finally reaches a river 6′. The agent finds a boat and crosses the river in the area of the border. The agent finds the proper path and a hidden boat, swims to the opposite bank and reaches the territory of the foreign country.

On the territory of the foreign country he finds a city 7, walks through city streets with trees, flowers, city transport, people around, stores, etc., and he reaches a building 8 of an enemy headquarter.

The building is guarded, and in order to enter it it is necessary to know a secret word. The agent waits near the entrance 9, hears another person entering the building announcing the same secret word and then gives the secret word to the entrance guard 10 so that he is allowed to go into the building. Naturally all these moves are controlled by player.

When the agent enters the building there is another guard, and he struggles with him, overwhelms him and puts him under the staircase. He walks from the first floor up several floors, he takes the uniform of the guard he overwhelmed, and this way reaches the floor he needs.

In the floor where secret document is hidden, another guard asks him a code word, he does not know the code word, and he again overwhelms the guard. Then he enters a room 11 in which a secret document is hidden, struggles with an officer who guards the secret document, forces him to give him a code for a lock in a secret document storage room, uses the code and opens the storage box 12.

There is a guard and the agent overwhelms the guard, opens the safe storage box 12 and takes the secret document 13.

The agent runs out of the building 8. The guards found that the safe storage box is open and run with dogs through the city. The agent runs through the territory of the foreign country and to the river, takes the boat, crosses the river, and brings the secret document to his superior who is a general. The general gives the agent a medal and valuable gift.

Of course, all moves of the image of the agent on the monitor are controller by a player. In the computer program there is also time counting, and the time spent for successive getting of the secret document is important to win the game. Always, in the secret program it is incorporated that the agent can not perform all tasks from the first attempt, but instead, he can fail and in this case the game starts from the very beginning.

It will be understood that each of the elements described above, or two or more together, may also find a useful application in other types of methods and constructions differing from the type described above.

While the invention has been illustrated and described as embodied in a computer game, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A computer game which has a computer with a computer program and a controller; and monitor for exhibiting an image of an agent moving toward the place where a secret document is hidden, wherein said computer program and said controller are designed so that a player by using said controller moves the image of an agent to overcome a plurality of obstacles to reach a foreign country, to travel in a foreign country, to find a building where the secret document is hidden, to overwhelm cards, to get in the building, to find the secret document, and to take it to his superiors.

2. A computer game as defined in claim 1, wherein said computer program and said controller are designed so that said moving includes moving from a point in one state to a state border and into a foreign country of the image of the agent, and then to the building.

3. A computer game as defined in claim 1, wherein said moving includes finding a boat and swimming over a river in the boat.

4. A computer game as defined in claim 1, wherein said computer program and said controller are designed so that getting into the building includes finding a code word and giving it to building guard.

5. A computer game as defined in claim 1, wherein said computer program and said controller are designed so that getting into the building includes overwhelming interior guards in the building.

6. A computer game as defined in claim 1, wherein getting a secret document includes overwhelming a guard and getting from him a code for opening a safe storage box which stores the secret document.

7. A computer game as defined in claim 1, wherein said computer program and said controller are designed so that said taking the secret document back includes bringing the secret document to a superior and obtaining a reward.

8. A method a computer game, comprising the steps of providing a computer with a computer program and a controller; and monitor for exhibiting an image of an agent moving toward the place where a secret document is hidden; and by a player using said controller to move an image of an agent to overcome a plurality of obstacles to reach a foreign country, to travel in a foreign country, to find a building where the secret document is hidden, to overwhelm cards, to get in the building, to find the secret document, and to take it to his superiors.

9. A method as defined in claim 8, wherein said moving includes pulling from a point in one state to a state boarder and into a foreign country of the image of the agent, and then to the building.

10. A method as defined in claim 9, wherein said moving includes finding a boat and swimming over a river in the boat.

11. A method as defined in claim 9, wherein said getting into the building includes finding a code word and giving it to a keyboard to building guard.

12. A method as defined in claim 9, wherein said getting into the building includes overwhelming interior guards in the building.

13. A method as defined in claim 9, wherein said getting a secret document includes overwhelming a guard and getting from him a code for opening a safe storage box which stores the secret document.

14. A method as defined in claim 9, wherein said taking the secret document back includes bringing the secret document to a superior and obtaining a reward.
